(19) United States
(12) Patent Application Publication
(10) Pub. No.: US 2026/0353111 A1
(43) Pub. Date: Nov. 5, 2026

(54) AI/ML MODEL CAPABILITY

(71) Applicant: ZTE Corporation, Shenzhen (CN)

(72) Inventors: Xingguang WEI, Shenzhen (CN); Wenfeng LIU, Shenzhen (CN); Zhaohua LU, Shenzhen (CN); Huahua XIAO, Shenzhen (CN); Yong LI, Shenzhen (CN); Lun LI, Shenzhen (CN)

(73) Assignee: ZTE Corporation, Shenzhen, GD (CN)

(21) Appl. No.: 19/728,715

(22) Filed: Jul. 2, 2026

Related U.S. Application Data
(63) Continuation of application No. PCT/CN2024/070891, filed on Jan. 5, 2024.

(51) Int. Cl. H04W 24/02

(52) U.S. Cl. CPC H04W 24/02

(57) ABSTRACT

A method includes a User Equipment (UE) indicating to a base station, a model related capability of the UE, which may include at least one of the following: a number of models that can be activated simultaneously, or a number of model processing units (MPU) that can be occupied simultaneously, wherein each model occupies a number of MPUs. The method may further include the base station managing the models according to the model related capability of the wireless terminal device.

### CROSS-REFERENCE TO RELATED APPLICATION(S)

This application is a continuation of International Patent Application No. PCT/CN2024/070891, filed Jan. 5, 2024. The contents of International Patent Application No. PCT/CN2024/070891 are herein incorporated by reference in their entirety.

### TECHNICAL FIELD

This disclosure generally relates to handling transmissions in a wireless cellular access network and is specifically directed to mechanisms for managing models activated at a User Equipment (UE) side according to UE's capability.

### BACKGROUND

Artificial Intelligence/Machine Learning (AI/ML) is a promising enhancement direction for mobile communication system, e.g., 5G (fifth generation), 5G-A (5G-Advanced) and 6G (sixth generation). With the introduction of AI/ML technology into the mobile communication system, the system operating efficiency is expected to be improved, for example, by reducing the overhead of reference signals via AI/ML inference and prediction.

For a communication system with AI/ML technology, an AI/ML model is adopted, for example, to perform inference. Generally, a model may refer to a functionality, function, functionality module, function module, processing method, information processing method, implementation, feature, feature group, configuration, configuration set, dataset (e.g., for model training), or data-driven algorithms. Generally, these models are performed, calculated, or processed by User Equipment (UE). In various examples, a model may be a data driven algorithm that applies AI/ML techniques to generate a set of outputs based on a set of inputs. Alternatively, a model can be linear or non-linear algorithms or combination of both algorithms. In addition, functionality may refer to a feature enabled by the AI/ML model. Alternatively, functionality may refer to a set of parameters or configurations for one feature. For example, a UE may adopt a convolutional neural network (CNN) model to predict the beams for the communication, and the CNN model is the model and the beam prediction is the functionality. Different models and/or functionalities may be associated with different configurations (e.g., Radio Resource Control (RRC) configuration). Model activation may refer to activating the corresponding configuration for the UE. Similarly, model deactivation, switching, and fallback may refer to deactivating the corresponding configuration, switching the configuration, and falling back to a configuration without the model, respectively.

Due to the limited processing capability, limited memory resources, and other potential hardware/software resource limitation, the models that can be activated for one UE across all the carriers/cells/bands are restricted. In other words, the models that a UE can use simultaneously across all the carriers/cells/bands are restricted.

### SUMMARY

This disclosure generally relates to handling transmissions in a wireless cellular access network and is specifically directed to mechanisms for managing models activated at a User Equipment (UE) side according to UE's capability.

When a model at the UE side is activated, the UE can apply this model to perform inference. However, each model consumes processing capability, memory resources, and other hardware/software resources. In order to better use the resources at the UE side, the UE may need to report its model related capabilities to the base station, and the base station may manage the models according to the UE capabilities.

In some exemplary implementations, a method performed by a wireless terminal device (e.g., a UE) includes indicating, to the WANN, a model related capability of the wireless terminal device. Similarly, a method performed by the WANN (e.g., wireless base station) includes receiving, from the wireless terminal device (e.g., UE) an indication of a model related capability of the wireless terminal device. The model related capability may include at least one of the following: a number of models that can be activated simultaneously, or a number of model processing units (MPU) that can be occupied simultaneously, wherein each model occupies a number of MPUs. The method may further include the WANN managing the models according to the model related capability of the wireless terminal device. The method may further include the WANN managing the models by at least one of activating one or more models, deactivating one or more models, switching to one or more models, updating one or more models, and/or falling back to a default operating mode with no model activated.

In some exemplary implementations, which may be combined with any of the other exemplary implementations disclosed herein, the methods may include the wireless terminal device 14 indicating to the WANN, and the WANN receiving an indication of a number of models that can be activated simultaneously for each resource unit, and a number of models that can be activated simultaneously across all resource units. The method may include the WANN activating a number of models in each resource unit that is not larger than the number of models that can be activated simultaneously for each resource unit indicated by the wireless terminal device for the corresponding resource unit, and activating a number of models activated by the WANN across all resource units that is not larger than the number of models that can be activated simultaneously across all resource units reported by the wireless terminal device. The method may also include the wireless terminal device indicating to the WANN, and the WANN receiving an indication of the number of models that can be activated simultaneously for each resource unit as Oₘ, 1≤m≤M, wherein M is a total number of resource units and is an integer larger than 0, and the number of models that can be activated simultaneously across all carrier as N, where

$$N \leq {\sum }_{m = 1}^{M} {O}_{m} ,$$

wherein the wireless terminal device supports no larger than Oₘ simultaneous activated models for a resource unit m, and no larger than N simultaneous activated models across all resource units. In various embodiments, a “resource unit” is one of a carrier, a cell, a band, or a bandwidth part (BWP).

In some exemplary implementations, which may be combined with any of the other exemplary implementations disclosed herein, the methods may include the wireless terminal device indicating to the WANN, and the WANN receiving an indication of a number of models that can be activated simultaneously for each cell group of the Q cell groups as Pₖ, where k is an integer, and where 1≤k≤Q, and wherein the wireless terminal device comprises Q cell groups. The method may also include the wireless terminal device indicating to the WANN, and the WANN receiving an indication of a number of models that can be activated across all Q cell groups as T, where

$$T \leq {\sum }_{k = 1}^{Q} {P}_{k} ,$$

wherein the wireless terminal device supports no larger than Pₖ simultaneous activated models for a cell group k, and no larger than T simultaneous activated models across all Q cell groups.

In some exemplary implementations, which may be combined with any of the other exemplary implementations disclosed herein, the methods may include the wireless terminal device indicating to the WANN, and the WANN receiving an indication of a number of MPUs that can be occupied simultaneously for each resource unit, and a number of MPUs that can be occupied simultaneously across all resource units. The number of MPUs occupied by the activated model in each resource unit is not larger than the number of MPUs that can be occupied simultaneously for each resource unit indicated by the wireless terminal device for the corresponding resource unit, and a number of MPUs occupied by the activated models across all resource units is not larger than the number of MPUs that can be occupied simultaneously across all resource units reported by the wireless terminal device. The methods may also include the wireless terminal device indicating to the WANN, and the WANN receiving an indication of the number of MPUs that can be occupied simultaneously for each resource unit as Oₘ, 1≤m≤M, wherein M is a total number of resource units and is an integer larger than 0, and the number of MPUs that can be occupied simultaneously across all resource units as N, where

$$N \leq {\sum }_{m = 1}^{M} {O}_{m} ,$$

wherein the wireless terminal device supports no larger than Oₘ simultaneous occupied MPUs for a resource unit m, and no larger than N simultaneous occupied MPUs across all resource units.

In some exemplary implementations, which may be combined with any of the other exemplary implementations disclosed herein, the methods may include the wireless terminal device indicating to the WANN, and the WANN receiving an indication of a number of MPUs that can be occupied simultaneously for each cell group of the Q cell groups as Pₖ, where k is an integer, and where 1≤k≤Q, and wherein the wireless terminal device comprises Q cell groups. The method may also include the wireless terminal device indicating to the WANN, and the WANN receiving an indication of a number of MPUs that can be occupied across all Q cell groups as T, where

$$T \leq {\sum }_{k = 1}^{Q} {P}_{k} ,$$

wherein the wireless terminal device supports no larger than Pₖ simultaneous occupied MPUs for a cell group k, and no larger than T simultaneous occupied MPUs across all Q cell groups.

In some exemplary implementations, which may be combined with any of the other exemplary implementations disclosed herein, each model may occupy 1 MPU; the wireless terminal device may indicate a number of occupied MPU for each model; or the wireless terminal device may indicate a number of occupied MPU for each use case or for each feature, wherein each model of the use case or feature occupies the number of MPUs indicated by the wireless terminal device.

In some exemplary implementations, which may be combined with any of the other exemplary implementations disclosed herein, the methods may include the wireless terminal device indicating to the WANN, and the WANN receiving an indication of a number of occupied MPUs (S) for one model for a band or a band combination, and a number of MPUs (T) that can be occupied simultaneously for the band or band combination, wherein a number of models (N) that can be activated for the band or band combination satisfies the following: S*N≤T. In other implementations, the methods may include the wireless terminal device indicating to the WANN, and the WANN receiving an indication of a number of occupied MPUs (S₁) for a single instance of one model for a band or band combination, and a number of occupied MPUs (S) for each of a plurality of the one model for the band or band combination, wherein S₁ is larger than S. When only one model is activated for the band or band combination, the occupied MPUs for this one model is S₁, and when there are a plurality (N) of the one model activated for the band or band combination, the total occupied MPUs for these N models is S₁+(N−1)·S. The methods may include the wireless terminal device indicating to the WANN, and the WANN receiving an indication of a number of MPUs (T) that can be occupied simultaneously for the band or band combination, wherein a number of models (N) that can be activated for the band or band combination satisfies the following: S₁+(N−1)·S≤T.

In some exemplary implementations, which may be combined with any of the other exemplary implementations disclosed herein, a model is considered as activated, or an MPU for this model is considered as occupied, from a starting time to an ending time, wherein the starting time can be one of the following: a next symbol or slot after the wireless terminal device receives a last symbol of a model activation command; a time offset after the wireless terminal device receives the last symbol of the model activation command; a next symbol or slot after the wireless terminal device transmits a Hybrid Automatic Repeat Request (HARQ) feedback for the model activation command; a time offset after the wireless terminal device transmits the HARQ feedback for the model activation command; a next symbol or slot after the wireless terminal device finishes the model activation command; a time offset after the wireless terminal device finishes the model activation command; or a time offset before the wireless terminal device starts receiving measurement resources for generating model input. Wherein the ending time can be one of the following: a next symbol or slot after the wireless terminal device receives a last symbol of a model deactivation command; a time offset after the wireless terminal device receives the last symbol of the model deactivation command; a next symbol or slot after the wireless terminal device transmits a Hybrid Automatic Repeat Request (HARQ) feedback for the model deactivation command; a time offset after the wireless terminal device transmits the HARQ feedback for the model deactivation command; a next symbol or slot after the wireless terminal device finishes the model deactivation command; a time offset after the wireless terminal device finishes the model deactivation command; a time offset after the wireless terminal device transmits a report of model output to the wireless access network node; or a time offset after a last symbol of a reference signal, where the wireless terminal device determines a model input based on the reference signal.

In some exemplary implementations, which may be combined with any of the other exemplary implementations disclosed herein, the methods may include the WANN indicating to the wireless terminal device, and the wireless terminal device receiving an indication to activate M models, where M and N are positive integer numbers and M is larger than N, where N is the number of models that can be activated simultaneously by the wireless terminal device. The method may include the wireless terminal device activating only the N models with a highest priority of the M models, and/or deactivating or refraining from activating the M-N models with a lowest priority of the M models. Also, the method may include the WANN indicating to the wireless terminal device, and the wireless terminal device receiving an indication to activate M models, wherein an occupied number of MPUs for each of the M models is U₁, U₂, . . . , and U_{M}, wherein a total number of occupied MPUs for the M models is

$${\sum }_{i = 1}^{M} {U}_{i}$$

and is larger than N, where N is the number of MPUs that can be occupied simultaneously by models activated by the wireless terminal device, and wherein M and N are positive integer numbers. The method may also include the wireless terminal device activating only the L models with a highest priority of the M models, and/or deactivating or refraining from activating the M-L models with lowest priority, such both of the following conditions are satisfied: Condition 1:

$${\sum }_{i = 1}^{L} {U}_{i} \leq N ,$$

### and Condition 2:

$${\sum }_{i = 1}^{L + 1} {U}_{i} > N .$$

In various examples, the priority of the M models is determined based on at least one of the following: a model with a smaller model index has a higher priority; a model activated in the resource unit with a smaller carrier index has a higher priority; a model activated later has a higher priority; a model with smaller MPUs has a higher priority; and/or a model with a smaller activation or inference delay has a higher priority.

In some other implementations, an apparatus for wireless communication such as a network device is disclosed. The network device may include one or more processors and one or more memories, wherein the one or more processors are configured to read computer code from the one or more memories to implement any one of the methods above. The apparatus for wireless communication may be the wireless access network node (e.g., base station) or the wireless terminal device (e.g., UE).

In yet some other implementations, a computer program product is disclosed. The computer program product may include a non-transitory computer-readable medium with computer code stored thereupon, the computer code, when executed by one or more processors, causing the one or more processors to implement any one of the methods above.

The above embodiments and other aspects and alternatives of their implementations are explained in greater detail in the drawings, the descriptions, and the claims below.

### BRIEF DESCRIPTION OF THE DRAWINGS

FIG. 1 shows a wireless access network with an exemplary uplink, downlink, and control channel configuration.

FIG. 2 shows various example processing components of the wireless terminal device and the wireless access network node of FIG. 1.

FIG. 3 shows an example communication timing diagram in accordance with various embodiments.

FIG. 4 shows an example timing diagram for model activation and deactivation in accordance with various embodiments.

### DETAILED DESCRIPTION

The technology and examples of implementations and/or embodiments described in this disclosure can be used to facilitate over-the-air radio resource allocation, configuration, and signaling in wireless access networks as well as operational configuration of a UE and/or a base station within the wireless access networks. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is directed to handling transmissions in a wireless cellular access network and is specifically directed to mechanisms for managing models activated at a User Equipment (UE) side according to UE's capability.

### Wireless Network Overview

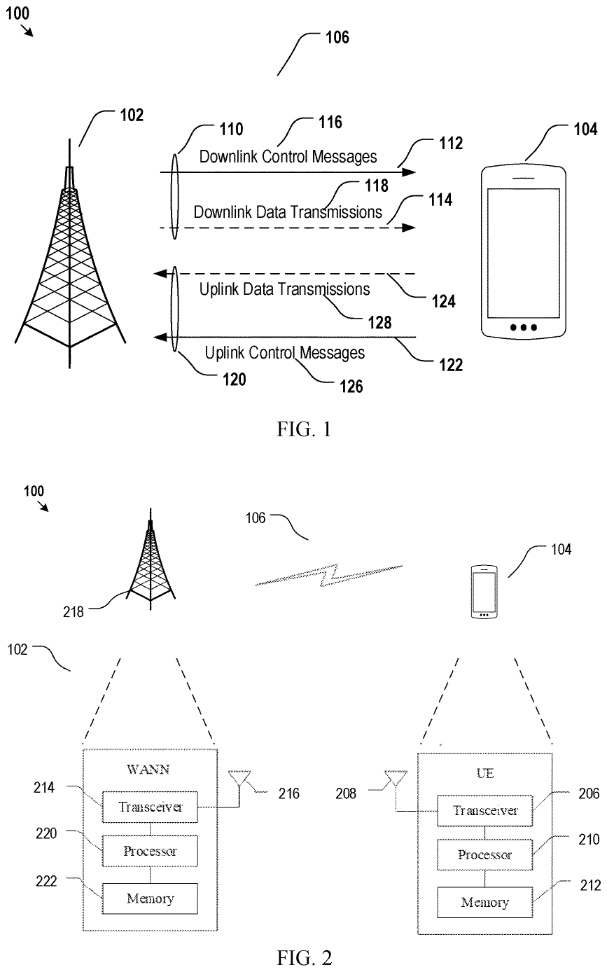

A wireless communication network may include a radio access network for providing network access to wireless terminal devices, and a core network for routing data between the access networks or between the wireless network and other types of data networks. In a wireless access network, radio resources are provided for allocation and used for transmitting data and control information. FIG. 1 shows an exemplary wireless access network 100 including a wireless access network node (WANN) or wireless base station 102 (herein referred to as wireless base station, base station, wireless access node, wireless access network node, or WANN) and a wireless terminal device or user equipment (UE) 104 (herein referred to as user equipment, UE, terminal device, or wireless terminal device) that communicates with one another via over-the-air (OTA) radio communication resources 106. The wireless access network 100 may be implemented as, as for example, a 2G, 3G, 4G/LTE, or 5G cellular radio access network. Correspondingly, the base station 102 may be implemented as a 2G base station, a 3G node B, an LTE eNB, or a 5G New Radio (NR) gNB. The user equipment 104 may be implemented as mobile or fixed communication devices installed with mobile identity modules for accessing the base station 102. The user equipment 104 may include but is not limited to mobile phones, laptop computers, tablets, personal digital assistants, wearable devices, distributed remote sensor devices, and desktop computers. Alternatively, the wireless access network 100 may be implemented as other types of radio access networks, such as Wi-Fi, Bluetooth, ZigBee, and WiMax networks.

FIG. 2 further shows example processing components of the WANN 102 and the UE 104 of FIG. 1. The UE 104, for example, may include transceiver circuitry 206 coupled to one or more antennas 208 to effectuate wireless communication with the WANN 102 (or to other UEs). The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the, functions, methods, and processes of the UE 104 described herein. The memory 212 may also store therein, and the processor 210 may also be configured to execute one or more models (e.g., Artificial Intelligence/Machine Learning (AI/ML) models) to perform one or more functionalities (e.g., AI/ML functionalities). The memory 212 may also be utilized and allocated for buffering UL and DL transmissions in each band/carrier. The memory 212 may include multiple memory modules assigned to different functions (such as program memory, base band memory, and/or RF memory, to name a few). Likewise, the WANN 102 may include transceiver circuitry 214 coupled to one or more antennas 216, which may include an antenna tower 218 in various forms, to effectuate wireless communications with the UE 104. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions, methods, and processes of the WANN 102 described herein.

### Wireless Communication Resource Scheduling/Signaling

Returning to FIG. 1, the radio communication resources for the over-the-air interface 106 may include a combination of frequency, time, and/or spatial communication resources organized into various resource units or elements in frequency, time, and/or space. The radio communication resources 106 in frequency domain may include portions of licensed radio frequency bands, portions of unlicensed ration frequency bands, or portions of a mix of both licensed and unlicensed radio frequency bands. The radio communication resources 106 available for carrying the wireless communication signals between the base station 102 and user equipment 104 may be further divided into physical downlink channels 110 for transmitting wireless signals from the base station 102 to the user equipment 104 and physical uplink channels 120 for transmitting wireless signals from the user equipment 104 to the base station 102. The physical downlink channels 110 may further include physical downlink control channels (PDCCHs) 112 and physical downlink shared channels (PDSCHs) 114. Likewise, the physical uplink channels 120 may further include physical uplink control channels (PUCCHs) 122 and physical uplink shared channels (PUSCHs) 124. For simplification, other types of downlink and uplink channels are not shown in FIG. 1 but are within the scope of the current disclosure. The control channels PDCCHs 112 and PUCCHs 122 may be used for carrying control information in the form of control messages 116 and 126, herein referred to as Downlink Control Information (DCI) messages or Uplink Control Information (UCI) messages. The shared channels (shared between data and control information) PDSCHs 114 and PUSCHs 124 may be allocated and used for communicating downlink data transmissions 118 and uplink data transmissions 128 between the base station 102 and the user equipment 104.

The allocation and configuration of the radio communication resources associated with the data channels, such as the PDSCHs and the PUSCHs may be provided by one or more resource scheduling DCIs carried in the PDCCHs. The PDCCHs may be shared by a plurality of UEs in the access network. In various approaches, a particular UE may be configured to perform blind decode procedures on a preconfigured UE-specific Search Space (USS) to detect and identify a payload of a resource scheduling DCI carried in the PDCCH that specifically targets the particular UE. The blind decoding may be performed on preconfigured monitoring occasions of the PDCCH associated with USS. Such monitoring occasions may be referred to as a set of PDCCH candidates. Each PDCCH candidate may be associated with a set of Control Channel Elements (CCEs). The UE may specifically use its Radio Network Temporary Identifier (RNTI) to decode the PDCCH candidates. The RNTI may be used to demask a PDCCH candidate's CRC. If no CRC error is detected, the UE determines that PDCCH candidate carries its own control information. The UE may then process the DCI and extract the resource allocation information pertaining to the PDSCH and/or PUSCH for receiving and/or transmitting data.

### Description of New Mechanisms for Managing Models at a UE

When a model at the UE 104 side is activated, the UE 104 can apply this model to perform inference. However, each model consumes processing capability, memory resources, and other hardware/software resources. In order to best utilize the resources at the UE 104, the UE 104 may need to report its model related capabilities to the base station 102, and the base station 102 can manage the models according to the UE capabilities.

In accordance with the present disclosure, methods are disclosed for a base station 102 to manage models executed on a UE 104 side based on the UE's 104 capabilities. In various embodiments, the UE 104 may indicate to the base station 102, and the base station may receive, an indication of the UE's model related capabilities. The model related capability may include at least one of the following:
A number of models that can be activated simultaneously; or
A number of model processing units (MPU) that can be occupied simultaneously, wherein each model occupies a number of MPUs. The base station 102 may then manage the models according to the UE capability. In various approaches, the base station 102 may manage the models by taking the information regarding the UE capability into account. For example, the base station 102 may avoid activating more models than the UE 104 can handle. Alternatively, the UE 104 may deactivate one or more models if there are more than it can handle, which deactivation may be determined by prioritization.

The MPU is used to reflect the required resources for utilizing the model(s), including all the required processing capability, memory resources, and other related hardware/software resources. Different models with different complexities may require different number MPUs. Similarly, because the resources of one UE 104 does not typically change, the supported simultaneous activated models depends on the complexity of models.

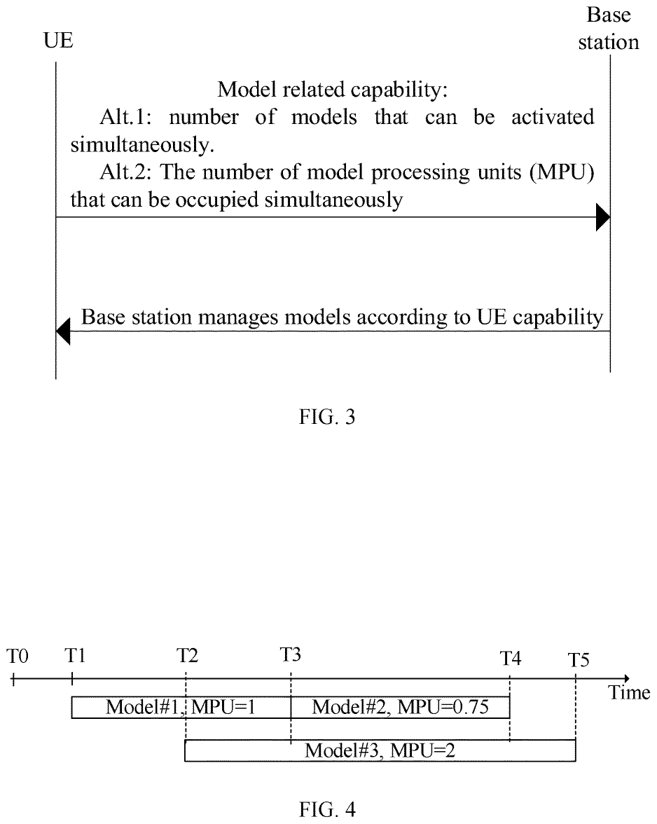

FIG. 3 shows an example communication timing diagram illustrating the above described procedure.

As such, in accordance with various embodiments, a method performed by the wireless terminal device 104 (e.g., UE 104) includes indicating, to the WANN 102, a model related capability of the wireless terminal device 104. Similarly, a method performed by the WANN 102 (e.g., wireless base station 102) includes receiving, from a wireless terminal device 104 (e.g., UE 104) an indication of a model related capability of the wireless terminal device. The model related capability may include at least one of the following: a number of models that can be activated simultaneously, or a number of model processing units (MPU) that can be occupied simultaneously, wherein each model occupies a number of MPUs. The method may further include the WANN 102 managing the models according to the model related capability of the wireless terminal device 104. The method may further include the WANN 102 managing the models by at least one of activating one or more models, deactivating one or more models, switching to one or more models, updating one or more models, and/or falling back to a default operating mode with no model activated.

The following embodiments are described with respect to “resource units.” In various embodiments, a “resource unit” is one of a carrier, a cell, a band, or a bandwidth part (BWP). For example, in some embodiments, the disclosed methods may be applied for each carrier, or for each cell and across all cells, or for each band and across all bands, or for each bandwidth part (BWP) and across all BWPs. To reduce the duplication, in some instances, the embodiments are described with respect to “carrier” below, however, the term “carrier” may be replaced with “cell,” “band,” or “BWP,” and the following description will apply equally or similarly. Also, the generic term “resource units” is also used herein, which represents a carrier, a cell, a band, or a BWP, generally.

When the model related capability is the number of models that can be activated simultaneously, the UE 104 may indicate the number of models that can be activated simultaneously for each resource unit (e.g., carrier, cell, band or BWP), and the UE 104 may indicate the number of models that can be activated simultaneously across all resource units.

The number of models activated by the base station 102 in each resource unit is not larger than the number of models that can be activated simultaneously for each resource unit reported by the UE 104 for the corresponding resource unit. The number of models activated by the base station 102 across all resource units is not larger than the number of models that can be activated simultaneously across all resource units reported by the UE 104.

For example, for the case of M resource units (e.g., carrier 1, carrier 2, . . . , carrier m), the UE 104 may indicate the number of models that can be activated simultaneously for each resource unit as Oₘ, 1≤m≤M. The UE 104 may indicate the number of models that can be activated simultaneously across all resource units as N, where

$$N \leq {\sum }_{m = 1}^{M} {O}_{m} ,$$

in this case, the UE limits the number of simultaneous activated models for each resource unit and across all resource units. M is an integer number larger than 0. The UE 104 supports no larger than Oₘ simultaneous activated models for resource unit m (e.g., carrier m) and no larger than N simultaneous activated models across all resource units.

For example, if the UE 104 is configured with 2 carriers and indicates the number of supported simultaneous activated models for each of the two carriers as 2 and 1, and the UE 104 indicates the number of supported simultaneous activated models across the two carriers as 2, then the UE 104 supports the following combinations of number of activated models, and the base station 102 manages the models at the UE 104 side accordingly.

| | Number of simultaneous | Number of simultaneous |
|---|---|---|
| Combination | models in the first carrier | models in the second carrier |
| 1 | 0 | 0 |
| 2 | 0 | 1 |
| 3 | 1 | 0 |
| 4 | 1 | 1 |
| 5 | 2 | 0 |

As such, the method may include the wireless terminal device 104 indicating to the WANN 102, and the WANN 102 receiving an indication of a number of models that can be activated simultaneously for each resource unit, and a number of models that can be activated simultaneously across all resource units. The method may include the WANN 102 activating a number of models in each resource unit that is not larger than the number of models that can be activated simultaneously for each resource unit indicated by the wireless terminal device 104 for the corresponding resource unit, and activating a number of models activated by the WANN 102 across all resource units that is not larger than the number of models that can be activated simultaneously across all resource units reported by the wireless terminal device 104. The method may also include the wireless terminal device 104 indicating to the WANN 102, and the WANN receiving an indication of the number of models that can be activated simultaneously for each resource unit as Oₘ, 1≤m≤M, wherein M is a total number of resource units and is an integer larger than 0, and the number of models that can be activated simultaneously across all carrier as N, where

$$N \leq {\sum }_{m = 1}^{M} {O}_{m} ,$$

wherein the wireless terminal device 104 supports no larger than Oₘ simultaneous activated models for a resource unit m, and no larger than N simultaneous activated models across all resource units.

In some instances, the UE 104 may be configured with more than one cell group. For example, in case of new radio (NR) Dual Connectivity (DC), the UE 104 is configured with two cell groups, i.e., one is the Master Cell Group (MCG) and another is the Secondary Cell Group (SCG). Each cell group includes one or more cells. In such instances where the UE 104 is configured with more than one cell group, the UE 104 may indicate the number of models that can be activated simultaneously for each cell group, and may indicate the number of models across all cell groups.

For example, if the UE 104 has Q cell groups (cell group 1, . . . , cell group Q), the UE 104 may indicate the number of models that can be activated simultaneously for each cell group as Pₖ, where k is an integer, and where 1≤k≤Q. The UE 104 may indicate the number of models that can be activated across all cell groups as T, where in one embodiment,

$$T \leq {\sum }_{k = 1}^{Q} {P}_{k} .$$

The UE 104 supports no larger than Pₖ simultaneous activated models for cell group k, and no larger than T simultaneous activated models across all cell groups.

As such, the method may include the wireless terminal device 104 indicating to the WANN 102, and the WANN receiving an indication of a number of models that can be activated simultaneously for each cell group of the Q cell groups as Pₖ, where k is an integer, and where 1≤k≤Q, and wherein the wireless terminal device 104 comprises Q cell groups. The method may also include the wireless terminal device 104 indicating to the WANN 102, and the WANN receiving an indication of a number of models that can be activated across all Q cell groups as T, where

$$T \leq {\sum }_{k = 1}^{Q} {P}_{k} ,$$

wherein the wireless terminal device supports no larger than Pₖ simultaneous activated models for a cell group k, and no larger than T simultaneous activated models across all Q cell groups.

In another embodiment, the UE 104 may indicate the number of models that can be activated simultaneously for each use case or feature. A use case or feature refers to one functionality that performed by the model, e.g., time domain beam predication, spatial domain beam prediction, CSI predication, CSI compression, positioning determination, etc. Models for different use cases or features can have different complexities, and thus the number of models that can be activated simultaneously for each use case or feature may be different.

When the model related capability is the number of MPUs that can be occupied simultaneously, the UE 104 may indicate the number of MPUs that can be occupied simultaneously for each resource unit (e.g., carrier, cell, band or BWP), and the UE 104 may indicate the number of MPUs that can be occupied simultaneously across all resource units.

The number of MPUs occupied by the activated model in each resource unit is not larger than the number of MPUs that can be occupied simultaneously for each resource unit reported by the UE 104 for the corresponding resource unit. The number of MPUs occupied by the activated models across all resource units is not larger than the number of MPUs that can be occupied simultaneously across all resource units reported by the UE 104.

For example, for the case of M resource units (e.g., carrier 1, carrier 2, . . . , carrier m), the UE 104 may indicate the number of MPUs that can be occupied simultaneously for each resource unit as Oₘ, 1≤m≤M. The UE 104 may indicate the number of MPUs that can be occupied simultaneously across all resource units as N, where

$$N \leq {\sum }_{m = 1}^{M} {O}_{m} ,$$

where M is an integer number larger than 0. The UE 104 supports no larger than Oₘ simultaneous occupied MPUs models for resource unit m (e.g., carrier m), and no larger than N simultaneous occupied MPUs across all resource units. Each model occupies a number of MPUs. As such, the UE 104 limits the number of simultaneous activated models for each resource unit and across all resource units.

As such, the method may include the wireless terminal device 104 indicating to the WANN 102, and the WANN receiving an indication of a number of MPUs that can be occupied simultaneously for each resource unit, and a number of MPUs that can be occupied simultaneously across all resource units. The number of MPUs occupied by the activated model in each resource unit is not larger than the number of MPUs that can be occupied simultaneously for each resource unit indicated by the wireless terminal device for the corresponding resource unit, and a number of MPUs occupied by the activated models across all resource units is not larger than the number of MPUs that can be occupied simultaneously across all resource units reported by the wireless terminal device. The method may also include the wireless terminal device 104 indicating to the WANN 102, and the WANN receiving an indication of the number of MPUs that can be occupied simultaneously for each resource unit as Oₘ, 1≤m≤M, wherein M is a total number of resource units and is an integer larger than 0, and the number of MPUs that can be occupied simultaneously across all resource units as N, where

$$N \leq {\sum }_{m = 1}^{M} {O}_{m} ,$$

wherein the wireless terminal device 104 supports no larger than Oₘ simultaneous occupied MPUs for a resource unit m, and no larger than N simultaneous occupied MPUs across all resource units.

As mentioned above, in some instances, the UE 104 may be configured with more than one cell group. In such instances where the UE 104 is configured with more than one cell group, the UE 104 may indicate the number of MPUs that can be occupied simultaneously for each cell group, and may indicate the number of MPUs that can be occupied simultaneously across all cell groups.

For example, if the UE 104 has Q cell groups (cell group 1, . . . , cell group Q), the UE 104 may indicate the number of MPUs that can be occupied simultaneously for each cell group as Pₖ, where k is an integer, and where 1≤k≤Q. The UE 104 may indicate the number of MPUs that can be occupied across all cell groups as T, where in one embodiment,

$$T \leq {\sum }_{k = 1}^{Q} {P}_{k} .$$

The UE 104 supports no larger than Pₖ simultaneous occupied MPUs for cell group k, and no larger than T simultaneous occupied MPUs across all cell groups.

As such, the method may include the wireless terminal device 104 indicating to the WANN 102, and the WANN receiving an indication of a number of MPUs that can be occupied simultaneously for each cell group of the Q cell groups as Pₖ, where k is an integer, and where 1≤k≤Q, and wherein the wireless terminal device 104 comprises Q cell groups. The method may also include the wireless terminal device 104 indicating to the WANN 102, and the WANN receiving an indication of a number of MPUs that can be occupied across all Q cell groups as T, where

$$T \leq {\sum }_{k = 1}^{Q} {P}_{k} ,$$

wherein the wireless terminal device supports no larger than Pₖ simultaneous occupied MPUs for a cell group k, and no larger than T simultaneous occupied MPUs across all Q cell groups.

Each model occupies a number of MPUs. The number of MPUs occupied by each model may be determined by at least one of the following alternatives.

Alternative 1: Each model occupies one MPU.

Alternative 2: The UE 104 indicates the number of occupied MPU for each model. For example, the UE 104 may indicate the occupied MPU as 1 for model #1 and 2 for model #2. If both model #1 and model #2 are activated, then they occupy 3 MPUs in total.

Alternative 3: The UE 104 indicates the number of occupied MPU for each use case or for each feature. Each model of the use case or feature occupies the number of MPUs indicated by the UE 104. Use case or feature refers to one functionality that is performed by the model, e.g., time domain beam predication, spatial domain beam prediction, CSI predication, CSI compression, positioning determination, etc. The UE 104 indicates the occupied MPU for one use case, then all the models for this case may occupy the same number of MPUs as indicated by the UE 104. If the UE 104 indicates the occupied MPU as 1.5 for time domain beam predication, and if two models (model #1 and model #2) are for time domain beam predication, then each of the two models occupies 1.5 MPUs once activated.

Alternative 4: The number of occupied MPU for each use case or for each feature is defined by default. For example, the specification defines the occupied MPU for each use case or feature refers.

In some instances, the UE 104 can share the same model across resource units (e.g., across carriers in the same band or in the same band combination). In this case, the sum number of occupied MPUs for this model can be reduced in the band or the band combination. Each band combination may include one or multiple bands. The UE 104 can indicate the band or band combination that supports model sharing for one model or for one use case to the base station 102.

In one embodiment, the UE 104 indicates the number of occupied MPUs (assuming the number is S) for one model for a band or a band combination for model sharing. Once the model is activated for one resource unit, the occupied MPUs for this model are added by this number (i.e., S). The UE 104 can also indicate the number of MPUs (assuming the number is T) that can be occupied simultaneously for the band or band combination. The total occupied MPUs for this band or band combination should be less than the number T. The number of models (assuming the number is N) that can be activated for this band or band combination should satisfy the following equation: S*N≤T.

For example, if the UE 104 indicates the occupied MPUs for the model for a band for model sharing as 0.75, and indicates the number of MPUs that can be occupied simultaneously for the band as 2, then the maximum number of models that can be activated for this band is 2, where the total occupied MPUs is 0.75*2=1.5. If 3 models are activated for this band (e.g., in three different carriers), then the total occupied MPUs for this band is 0.75*3=2.25, which is larger than the number of MPUs that can be occupied simultaneously indicated by the UE.

As such, the method may include the wireless terminal device 104 indicating to the WANN 102, and the WANN receiving an indication of a number of occupied MPUs (S) for one model for a band or a band combination, and a number of MPUs (T) that can be occupied simultaneously for the band or band combination, wherein a number of models (N) that can be activated for the band or band combination satisfies the following: S*N≤T.

In one embodiment, the UE 104 indicates the number of occupied MPUs (assuming the number is S₁) for one model for a band or band combination when there is only one model activated for this band or band combination. And the UE 104 indicates the number of occupied MPUs (assuming the number is S) for one model for a band or a band combination for model sharing when there is more than one model activated for this band or band combination.

If there is only one model activated for this band or band combination, the occupied MPUs for this model is S₁. However, if there is more than one model activated for this band or band combination and the number of activated models is N, then the total occupied MPUs for these N models are S₁+(N−1)·S.

UE can also indicate the number of MPUs (assuming the number is T) that can be occupied simultaneously for the band or band combination. The total occupied MPUs for this band or band combination should be less than the number T. The number of models that can be activated for this band or band combination should satisfy the following equation: S₁+(N−1)·S≤T.

Normally, in order to perform model sharing, S₁ is larger than S because once the model is activated, less resource will be occupied if they are going to share the same model.

For example, if the UE 104 indicates the occupied MPUs for the model for a band for model sharing as 1 when there is only model activated, and indicates the occupied MPUs for the model when there is more than one model activated as 0.5, and the UE 104 indicates the number of MPUs that can be occupied simultaneously for the band as 2, then the maximum number of models that can be activated for this band is 3, where the total occupied MPUs is 1+0.5*2=2.

As such, the method may include the wireless terminal device 104 indicating to the WANN 102, and the WANN receiving an indication of a number of occupied MPUs (S₁) for a single instance of one model for a band or band combination, and a number of occupied MPUs (S) for each of a plurality of the one model for the band or band combination, wherein S₁ is larger than S. When only one model is activated for the band or band combination, the occupied MPUs for this one model is S₁, and when there are a plurality (N) of the one model activated for the band or band combination, the total occupied MPUs for these N models is S₁+(N−1)·S. The method may include the wireless terminal device 104 indicating to the WANN 102, and the WANN receiving an indication of a number of MPUs (T) that can be occupied simultaneously for the band or band combination, wherein a number of models (N) that can be activated for the band or band combination satisfies the following: S₁+(N−1). S≤T.

### Timeline

In terms of the model related capability, the model is considered as activated or the MPU for this model is considered as occupied from a starting time to an ending time.

In various embodiments, the starting time can be one of the following alternatives: Alternative 0: The time when the UE 104 activates the model.

Alternative 1: The next symbol/slot after the UE 104 receives the last symbol of the model activation command.

Alternative 2: A time offset after the UE 104 receives the last symbol of the model activation command. The time offset can be one or multiple symbols/slots/milliseconds for the UE 104 to process the model activation command. The time offset can be small (e.g., 0 to 1 ms) if the UE 104 processes the model activation command fast.

Alternative 3: The next symbol/slot after the UE 104 transmits the HARQ feedback for model activation command.

Alternative 4: A time offset after the UE 104 transmits the HARQ feedback for model activation command. The time offset can be one or multiple symbols/slots/milliseconds for the UE 104 to process the model activation command. The time offset can also be small (e.g., 0 to 1 ms) if the UE 104 processes the model activation command fast. Typical value for this offset can be 3 ms if the model activation command is MAC-CE.

Alternative 5: The next symbol/slot after the UE 104 finishes the model activation command.

Alternative 6: A time offset after the UE 104 finishes the model activation command. The time offset can be one or multiple symbols/slots/milliseconds for potential time misalignment between the UE 104 and the base station 102.

Alternative 7: A time offset before the UE 104 starts receiving the measurement resources for generating model input. The measurement resources can be reference signal or dataset. In one embodiment, the UE 104 may measure the reference signal and use the measurement results (e.g., CSI, PMI, RSRP) as the model input. In another embodiment, the UE 104 may receive the dataset which includes the model input. The time offset is used for model to warm up. The time offset can be one or multiple symbols/slots/milliseconds for the UE 104 to warm up the model. The time offset can also be small (e.g., 0 to 1 ms) if the UE 104 warms up the model fast.

The ending time can be one of the following alternatives:

Alternative 0: The time when the UE 104 deactivates the model.

Alternative 1: The next symbol/slot after the UE 104 receives the last symbol of the model deactivation command.

Alternative 2: A time offset after the UE 104 receives the last symbol of the model deactivation command. The time offset can be one or multiple symbols/slots/milliseconds for the UE 104 to process the model deactivation command. The time offset can be small (e.g., 0 to 1 ms) if the UE 104 processes the model deactivation command fast.

Alternative 3: The next symbol/slot after the UE 104 transmits the HARQ feedback for model deactivation command.

Alternative 4: A time offset after the UE 104 transmits the HARQ feedback for model deactivation command. The time offset can be one or multiple symbols/slots/milliseconds for the UE 104 to process the model deactivation command. The time offset can be small (e.g., 0 to 1 ms) if the UE 104 processes the model deactivation command fast. Typical value for this offset can be 3 ms if the model deactivation command is MAC-CE.

Alternative 5: The next symbol/slot after the UE 104 finishes the model deactivation command.

Alternative 6: A time offset after the UE 104 finishes the model deactivation command. The time offset can be one or multiple symbols/slots/milliseconds for potential time misalignment between the UE 104 and the base station 102.

Alternative 7: A time offset after the UE 104 transmits the report of model output to the base station. The report of the model output can be the model output itself or metrics derived based on the model output. In one embodiment, the model output can be CSI, precoding matrix information, best beam index(es), RSRP of the all the beam(s), RSSI, RSRQ, SINR, BLER, BER, UE location, channel phase/power/time information, etc. In another embodiment, the metrics derived based on the model output can be CSI, precoding matrix information, best beam index(es), RSRP of the best beam(s), RSSI, RSRQ, SINR, BLER, BER, UE location, channel phase/power/time information, etc. based on the model output. For example, the model output can be RSRP of all the beam(s) and the metrics derived based on the model output can be the best beam index. The time offset is used for model to warp up. The time offset can be one or multiple symbols/slots/milliseconds for UE to wrap up the model. The time offset can also be small (e.g., 0 to 1 ms) if the UE 104 wraps up the model fast.

Alternative 8: A time offset after the last symbol of the reference signal, where the UE 104 determines the model input based on the reference signal. The UE 104 may measure the reference signal and derive the model input based on the reference signal. The time offset is used for the UE 104 to perform inference, which can be one or multiple symbols/slots/milliseconds for the UE 104.

FIG. 4 illustrates an example timing diagram for model activation and deactivation in accordance with various embodiments. Taking FIG. 4 as an example, and assuming the above Alternative 0 is adopted, Model #1 is activated at time T1 and deactivated at time T3. Model #1 occupies 1 MPU between time T1 and T2. Model #2 is activated at time T3 and deactivated at time T4. Model #2 occupies 0.75 MPU between time T3 and T4. Model #3 is activated at time T2 and deactivated at time T5. Model #3 occupies 2 MPUs between time T2 and T5.

As such, in this example, it can be seen that:

From time T0 to time T1, 0 models are activated and 0 MPUs are occupied.

From time T1 to time T2, 1 model is activated and 1 MPU is occupied.

From time T2 to time T3, 2 models are activated and 3 MPUs are occupied.

From time T3 to time T4, 2 models are activated and 2.75 MPUs are occupied.

From time T4 to time T5, 1 model is activated and 2 MPUs are occupied.

### Prioritization

Normally, the base station 102 guarantees that the number of activated models or the total occupied MPUs does not exceed the UE's 104 capability. However, in some cases, the base station 102 may indicate the UE 104 to activate a number of models that exceeds the UE's 104 capability, e.g., in case one command activates multiple models for multiple UEs. To address this situation and others, prioritization rules are defined such that the UE 104 knows which models should be activated and which should not.

In case the UE 104 indicates the number of models that can be activated simultaneously as N, and the base station 102 indicates the UE 104 to activate M models, where M and N are positive integer numbers and Mis larger than N, the UE 104 does not activate the M−N (M minus N) models with a lowest priority, or the UE 104 deactivates the M−N models with a lowest priority. As such, the method may include the WANN 102 indicating to the wireless terminal device 104, and the wireless terminal device 104 receiving an indication to activate M models, where M and N are positive integer numbers and M is larger than N, where Nis the number of models that can be activated simultaneously by the wireless terminal device. The method may include the wireless terminal device 104 activating only the N models with a highest priority of the M models, and/or deactivating or refraining from activating the M−N models with a lowest priority of the M models.

In case the UE 104 indicates the number of MPUs that can be occupied simultaneously as N, and the base station 102 indicates UE 104 to activate M models, where the occupied number of MPUs for each of the M models is U₁, U₂, . . . , and U_{M}, M and N are positive integer numbers and

$${\sum }_{i = 1}^{M} {U}_{i}$$

is larger than N, the UE 104 only activates the L models with a highest priority, or the UE 104 deactivates the M−L (M minus L) models with lowest priority such both of the following conditions are satisfied:

$$Condition 1 : {\sum }_{i = 1}^{L} {U}_{i} \leq N .$$

$$Condition 2 : {\sum }_{i = 1}^{L + 1} {U}_{i} > N .$$

As such, the method may include the WANN 102 indicating to the wireless terminal device 104, and the wireless terminal device 104 receiving an indication to activate M models, wherein an occupied number of MPUs for each of the M models is U₁, U₂, . . . , and U_{M}, wherein a total number of occupied MPUs for the M models is

$${\sum }_{i = 1}^{M} {U}_{i}$$

and is larger than N, where Nis the number of MPUs that can be occupied simultaneously by models activated by the wireless terminal device, and wherein M and N are positive integer numbers. The method may also include the wireless terminal device 104 activating only the L models with a highest priority of the M models, and/or deactivating or refraining from activating the M−L models with lowest priority, such both of the following conditions are satisfied: Condition 1

$${\sum }_{i = 1}^{L} {U}_{i} \leq N ,$$

### and Condition 2:

$${\sum }_{i = 1}^{L + 1} {U}_{i} > N .$$

The priority of the models may be determined based on at least one of the following:

Alternative 1: The model with smaller model index has a higher priority.

Alternative 2: The model activated in the resource unit (carrier/cell/band/BWP) with smaller carrier index has a higher priority.

Alternative 3: The model activated later has a higher priority.

Alternative 4: The model with smaller MPUs has a higher priority.

Alternative 5: The model with smaller activation/inference delay has a higher priority.

In another embodiment, the priority of the models is determined based on at least one of the following:

Alternative 1: The model with smaller model index is with lower priority.

Alternative 2: The model activated in the carrier/cell/band/BWP with smaller carrier index is with lower priority.

Alternative 3: The model activated later is with lower priority.

Alternative 4: The model with smaller MPUs is with lower priority.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation/example/approach” as used herein does not necessarily refer to the same embodiment and the phrase “in another embodiment/implementation/example/approach” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed is:

1. A method performed by a wireless terminal device comprising:
indicating, to a wireless access network node, an artificial intelligence (AI)/machine learning (ML) functionality related capability of the wireless terminal device, wherein the AI/ML functionality related capability includes at least one of the following:
a number of models that can be activated simultaneously, or
a number of model processing units (MPU) that can be occupied simultaneously, wherein each of one or more AI/ML functionalities occupies a number of MPUs, and
wherein the one or more AI/ML functionalities are managed by the wireless access network node according to the AI/ML functionality related capability of the wireless terminal device.

2. The method according to claim 1,
wherein the one or more AI/ML functionalities are managed by at least one of activating at least one of the one or more AI/ML functionalities, deactivating at least one of the one or more AI/ML functionalities, switching to at least one of the one or more AI/ML functionalities, updating at least one of the one or more AI/ML functionalities, and/or falling back to a default operating mode with none of the one or more AI/ML functionalities activated.

3. The method according to claim 1, further comprising:
indicating, to the wireless access network node, a number of models that can be activated simultaneously for each resource unit, and a number of models that can be activated simultaneously across all resource units,
wherein a number of models activated by the wireless access network node in each resource unit is not larger than the number of models that can be activated simultaneously for each resource unit indicated by the wireless terminal device for the corresponding resource unit, and wherein a number of models activated by the wireless access network node across all resource units is not larger than the number of models that can be activated simultaneously across all resource units reported by the wireless terminal device.

4. The method according to claim 3, further comprising:
indicating, to the wireless access network node, the number of models that can be activated simultaneously for each resource unit as Oₘ, 1≤m≤M, wherein M is a total number of resource units and is an integer larger than 0; and
indicating, to the wireless access network node, the number of models that can be activated simultaneously across all resource units as N, where
$$N \leq {\sum }_{m = 1}^{M} {O}_{m} ,$$
wherein the wireless terminal device supports no larger than Oₘ simultaneous activated models for a resource unit m, and no larger than N simultaneous activated models across all resource units.

5. The method according to claim 1, further comprising:
indicating, to the wireless access network node, a number of MPUs that can be occupied simultaneously for each resource unit, and a number of MPUs that can be occupied simultaneously across all resource units,
wherein a number of MPUs occupied by at least one of the one or more AI/ML functionalities activated in each resource unit is not larger than the number of MPUs that can be occupied simultaneously for each resource unit indicated by the wireless terminal device for the corresponding resource unit, and wherein a number of MPUs occupied by the at least one of the one or more AI/ML functionalities activated across all resource units is not larger than the number of MPUs that can be occupied simultaneously across all resource units reported by the wireless terminal device.

6. The method according to claim 5, further comprising:
indicating, to the wireless access network node, the number of MPUs that can be occupied simultaneously for each resource unit as Oₘ, 1≤m≤M, wherein M is a total number of resource units and is an integer larger than 0; and
indicating, to the wireless access network node, the number of MPUs that can be occupied simultaneously across all resource units as N, where
$$N \leq {\sum }_{m = 1}^{M} {O}_{m} ,$$
wherein the wireless terminal device supports no larger than Oₘ simultaneous occupied MPUs for a resource unit m, and no larger than N simultaneous occupied MPUs across all resource units.

7. The method according to claim 1,
wherein each model occupies 1 MPU;
wherein the wireless terminal device indicates a number of occupied MPU for each of the one or more AI/ML functionalities; or
wherein the wireless terminal device indicates a number of occupied MPU for each use case or for each feature, wherein each model of the use case or feature occupies the number of MPUs indicated by the wireless terminal device.

8. The method according to claim 1, further comprising:
receiving, from the wireless access network node, an indication to activate M AI/ML functionalities, where M and N are positive integer numbers and M is larger than N, where N is the number of the one or more AI/ML functionalities that can be activated simultaneously by the wireless terminal device; and
activating only the N AI/ML functionalities with a highest priority of the M AI/ML functionalities, and/or deactivating or refraining from activating the M−N AI/ML functionalities with a lowest priority of the M AI/ML functionalities.

9. The method according to claim 1, further comprising:
receiving, from the wireless access network node, an indication to activate M AI/ML functionalities, wherein an occupied number of MPUs for each of the M AI/ML functionalities is U₁, U₂, . . . , and U_{M}, wherein a total number of occupied MPUs for the M AI/ML functionalities is
$${\sum }_{i = 1}^{M} {U}_{i}$$
and is larger than N, where N is the number of MPUs that can be occupied simultaneously by AI/ML functionalities activated by the wireless terminal device, and wherein M and N are positive integer numbers; and
activating only the L AI/ML functionalities with a highest priority of the M AI/ML functionalities, and/or deactivating or refraining from activating the M−L AI/ML functionalities with lowest priority, such both of the following conditions are satisfied:
$$Condition 1 : {\sum }_{i = 1}^{L} {U}_{i} \leq N , and$$
$$Condition 2 : {\sum }_{i = 1}^{L + 1} {U}_{i} > N .$$

10. The method according to claim 8,
wherein the priority of the M AI/ML functionalities is determined based on at least one of the following:
an AI/ML functionality with a smaller AI/ML functionality index has a higher priority;
an AI/ML functionality activated in the resource unit with a smaller carrier index has a higher priority;
an AI/ML functionality activated later has a higher priority;
an AI/ML functionality with smaller MPUs has a higher priority; and/or
an AI/ML functionality with a smaller activation or inference delay has a higher priority.

11. The method according to claim 1,
wherein an AI/ML functionality is considered as activated, or an MPU for this AI/ML functionality is considered as occupied, from a starting time to an ending time,
wherein the starting time can be one of the following:
a next symbol or slot after the wireless terminal device receives a last symbol of a AI/ML functionality activation command;
a time offset after the wireless terminal device receives the last symbol of the AI/ML functionality activation command;
a next symbol or slot after the wireless terminal device transmits a Hybrid Automatic Repeat Request (HARQ) feedback for the AI/ML functionality activation command;
a time offset after the wireless terminal device transmits the HARQ feedback for the AI/ML functionality activation command;
a next symbol or slot after the wireless terminal device finishes the AI/ML functionality activation command;
a time offset after the wireless terminal device finishes the AI/ML functionality activation command; or
a time offset before the wireless terminal device starts receiving measurement resources for generating model input.

12. The method according to claim 1,
wherein an AI/ML functionality is considered as activated, or an MPU for this AI/ML functionality is considered as occupied, from a starting time to an ending time,
wherein the ending time can be one of the following:
a next symbol or slot after the wireless terminal device receives a last symbol of an AI/ML functionality deactivation command;
a time offset after the wireless terminal device receives the last symbol of the AI/ML functionality deactivation command;
a next symbol or slot after the wireless terminal device transmits a Hybrid Automatic Repeat Request (HARQ) feedback for the AI/ML functionality deactivation command;
a time offset after the wireless terminal device transmits the HARQ feedback for the AI/ML functionality deactivation command;
a next symbol or slot after the wireless terminal device finishes the AI/ML functionality deactivation command;
a time offset after the wireless terminal device finishes the AI/ML functionality deactivation command;
a time offset after the wireless terminal device transmits a report of model output to the wireless access network node; or
a time offset after a last symbol of a reference signal, where the wireless terminal device determines a model input based on the reference signal.

13. An apparatus for wireless communication comprising a processor that is configured to carry out the method of claim 1.

14. A method performed by a wireless access network node comprising:
receiving, from a wireless terminal device, an indication of an artificial intelligence (AI)/machine learning (ML) functionality related capability of the wireless terminal device, wherein the AI/ML functionality related capability includes at least one of the following:
a number of models that can be activated simultaneously, or
a number of model processing units (MPU) that can be occupied simultaneously, wherein each of one or more AI/ML functionalities occupies a number of MPUs, and
managing, by the wireless access network node, the one or more AI/ML functionalities according to the AI/ML functionality related capability of the wireless terminal device.

15. The method according to claim 14,
wherein managing the AI/ML functionalities comprises at least one of: activating at least one of the one or more AI/ML functionalities, deactivating at least one of the one or more AI/ML functionalities, switching to at least one of the one or more AI/ML functionalities, updating at least one of the one or more AI/ML functionalities, and/or falling back to a default operating mode with none of the one or more AI/ML functionalities activated.

16. The method according to claim 14, further comprising:
receiving, from the wireless terminal device, an indication of a number of models that can be activated simultaneously for each resource unit, and a number of models that can be activated simultaneously across all resource units; and
activating a number of models in each resource unit that is not larger than the number of models that can be activated simultaneously for each resource unit indicated by the wireless terminal device for the corresponding resource unit; and
activating a number of models activated by the wireless access network node across all resource units that is not larger than the number of models that can be activated simultaneously across all resource units reported by the wireless terminal device.

17. The method according to claim 16, further comprising:
receiving, from the wireless terminal device, an indication of the number of models that can be activated simultaneously for each resource unit as Oₘ, 1≤m≤M, wherein M is a total number of resource units and is an integer larger than 0; and
receiving, from the wireless terminal device, an indication of the number of models that can be activated simultaneously across all carrier as N, where
$$N \leq {\sum }_{m = 1}^{M} {O}_{m} ,$$
wherein the wireless terminal device supports no larger than Oₘ simultaneous activated models for a resource unit m, and no larger than N simultaneous activated models across all resource units.

18. The method according to claim 14, further comprising:
receiving, from the wireless terminal device, an indication of a number of MPUs that can be occupied simultaneously for each resource unit, and a number of MPUs that can be occupied simultaneously across all resource units,
wherein a number of MPUs occupied by at least one of the one or more AI/ML functionalities activated in each resource unit is not larger than the number of MPUs that can be occupied simultaneously for each resource unit indicated by the wireless terminal device for the corresponding resource unit, and wherein a number of MPUs occupied by the at least one of the one or more AI/ML functionalities activated across all resource units is not larger than the number of MPUs that can be occupied simultaneously across all resource units reported by the wireless terminal device;
receiving, from the wireless terminal device, an indication of the number of MPUs that can be occupied simultaneously for each resource unit as Oₘ, 1≤m≤M, wherein M is a total number of resource units and is an integer larger than 0; and
receiving, from the wireless terminal device, an indication of the number of MPUs that can be occupied simultaneously across all carrier as N, where
$$N \leq {\sum }_{m = 1}^{M} {O}_{m} ,$$
wherein the wireless terminal device supports no larger than Oₘ simultaneous occupied MPUs for a resource unit m, and no larger than N simultaneous occupied MPUs across all resource units.

19. The method according to claim 14,
wherein each model occupies 1 MPU;
wherein the wireless terminal device indicates a number of occupied MPU for each of the one or more AI/ML functionalities; or
wherein the wireless terminal device indicates a number of occupied MPU for each use case or for each feature, wherein each model of the use case or feature occupies the number of MPUs indicated by the wireless terminal device.

20. An apparatus for wireless communication comprising a processor that is configured to carry out the method of claim 14.
